(19) United States
(12) Patent Application Publication
(10) Pub. No.: US 2010/0078904 A1
(43) Pub. Date: Apr. 1, 2010

(54) Mobile Medical Wash Stations and Nurses' Stations

(76) Inventor: Jeffery A. COLLINS, Boerne, TX (US)

Correspondence Address: KAMMER BROWNING PLLC, 7700 BROADWAY, SUITE 202, SAN ANTONIO, TX, 78209, US

(21) Appl. No.: 12/545,046

(22) Filed: Aug. 20, 2009

Related U.S. Application Data
(60) Provisional application No. 61/090,605, filed on Aug. 20, 2008.

(51) Int. Cl. B62B 3/00; A47K 1/04

(52) U.S. Cl. 280/47.11; 4/630

(57) ABSTRACT

Disclosed are medical systems associated with mobile and/or emergency response capabilities. The mobile medical carts and cabinets of the present invention facilitate the activities of a nurse and/or other health care providers in remote (non-hospital) environments. The mobile medical units include a mobile medical wash station that provides a wash sink/faucet and counter top structure that allows health care provides to carry out their services in a hygienic manner. The unit provides as close to an in hospital wash station as possible on a mobile platform and includes external connections to an electrical power source and a pressurized water supply. The present invention further includes a mobile medical nurses' station that provides most if not all of the same functionality of a fixed nurses' station within a hospital. The units are each supported on mobile cart platforms that allow for easy movement and set-up in field locations.

### CROSS REFERENCES TO RELATED APPLICATIONS

This application claims the benefit under Title 35 United States Code §119(e) of U.S. Provisional Application 61/090,605 filed Aug. 20, 2008 the full disclosure of which is incorporated herein by reference

### BACKGROUND OF THE INVENTION

1. Field of the Invention

The present invention relates generally to medical systems associated with mobile and/or emergency response capabilities. The present invention relates more specifically to mobile medical carts and cabinets that facilitate the activities of a nurse and/or other health care provider in remote (non-hospital) environments.

2. Description of the Related Art

Some efforts have been made in the past to provide mobile units to facilitate the activities of health care providers in the field (away from the fixed hospital environment). Most of the prior efforts suffer from one or more deficiencies, typically requiring large self contained water tanks and associated pumps and plumbing. Some attempt to achieve the needed benefits without the use of electricity while others provide self contained generators. All of these efforts tend to be either too complex while providing the desired facilities, or incomplete while trying to remain simple and efficient.

In reality, most environments where the use of such mobile medical units is required will have some access to potable water and to electricity. It would therefore be desirable to have medical cart systems that strike a balance between complexity and efficiency. Systems that were not fully self-contained, i.e. they utilized access to potable (pressurized) water supplies and to standard electrical power sources, would be preferable over the systems described in the related art.

### BRIEF DESCRIPTION OF THE DRAWINGS

FIG. 1 is a perspective view of the mobile medical wash station of the present invention.

FIG. 2 is a front perspective view of the mobile medical wash station of the present invention showing the interior components of the cabinet.

FIG. 3 is a front perspective view of the mobile medical wash station of the present invention shown with the cover component lowered and latched in place for transport.

FIG. 4 is a side perspective view of the mobile medical wash station of the present invention showing the interior components on the side of the cabinet.

FIG. 5 is a rear perspective view of the mobile medical wash station of the present invention showing the interior components and the external connections of the system.

FIG. 6 is a front plan view of the mobile medical wash station of the present invention showing its preferred dimensions.

FIG. 7 is a side plan view of the mobile medical wash station of the present invention showing its preferred dimensions.

FIG. 8 is a perspective view of the mobile medical wash station of the present invention showing the manner of its use.

FIGS. 9A-9C are left side, center, and right side perspective views of the mobile medical nurses' station of the present invention.

FIG. 10 is a perspective view of the mobile medical nurses' station of the present invention showing the open cabinets and drawers of the system.

### DETAILED DESCRIPTION OF THE PREFERRED EMBODIMENTS

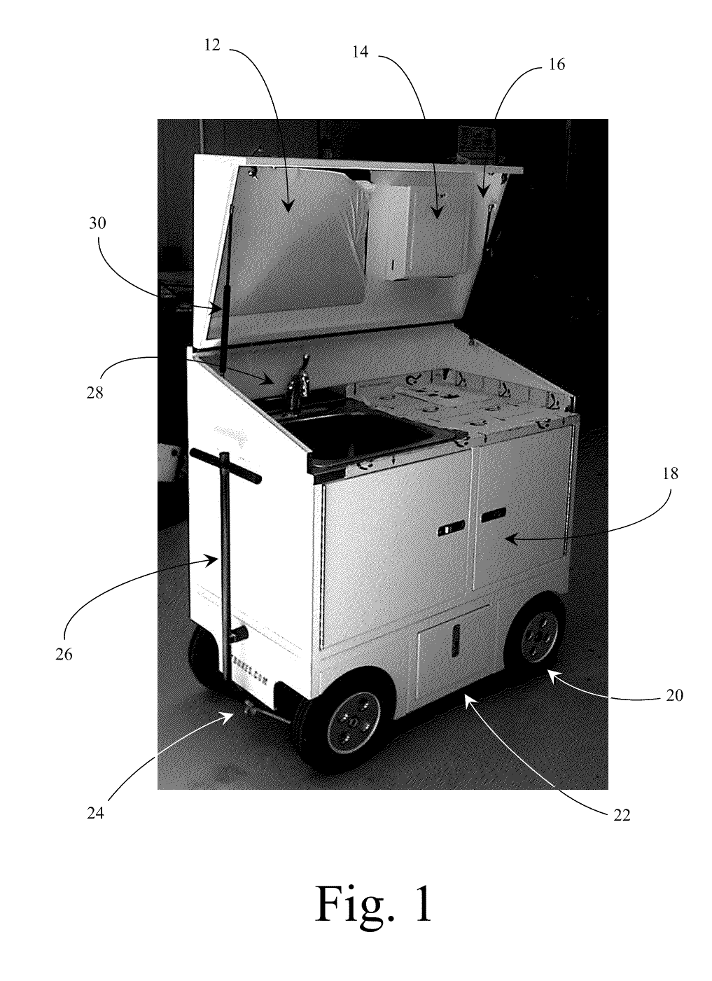

Reference is made first to FIG. 1 for a brief description of the mobile medical wash station of the present invention. In this view, the mobile station is shown to include four wheels 20, at least two of which are situated on a carriage 24 that allows them to turn when directed by pull cart handle 26. The station includes two cabinet doors 18 and a hinged cover component 16. When opened, cover component 16 supports a towel dispenser 14 and a mirror 12. Hydraulic or pneumatic cylinders 30 support the hinged cover 16 in its open position. A work/counter area and a sink with faucet 28 are positioned within the unit. An additional storage compartment 22 is provided in the form of a drawer on the lower front of the unit.

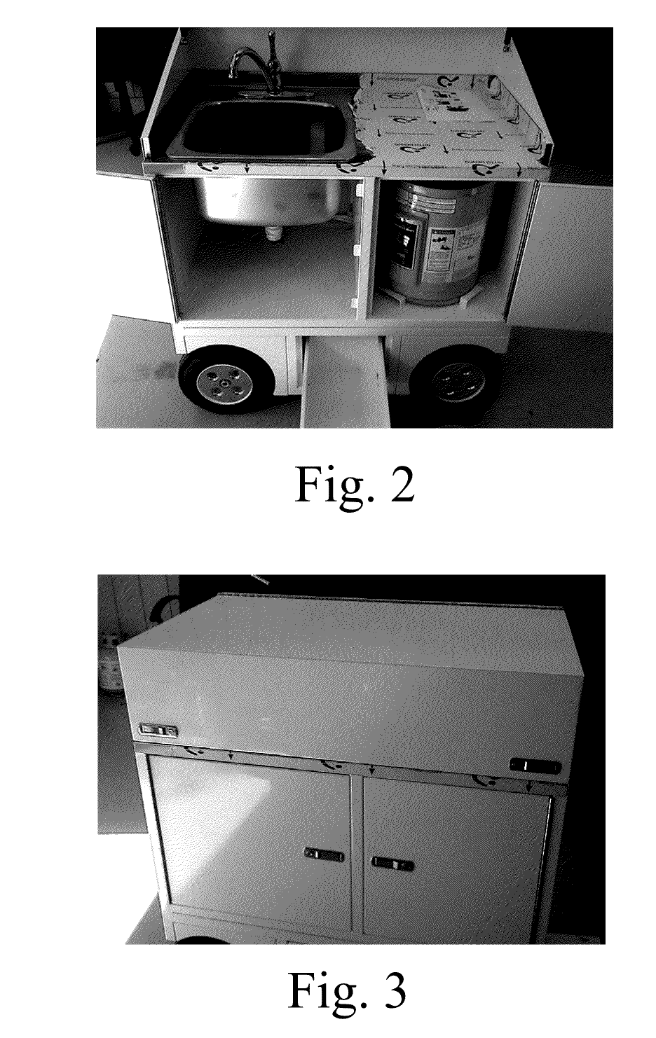

FIG. 2 is a front perspective view of the mobile medical wash station of the present invention showing the interior components of the cabinet. Visible in this view are the sink and drain components of the system and a compact hot water heater unit.

FIG. 3 is a front perspective view of the mobile medical wash station of the present invention shown with the cover component lowered and latched in place for transport. In this position the station is completely enclosed and protected during transport to and from the location of its intended use. Secure latches on the cover component and on the cabinet doors keep the unit closed for transport.

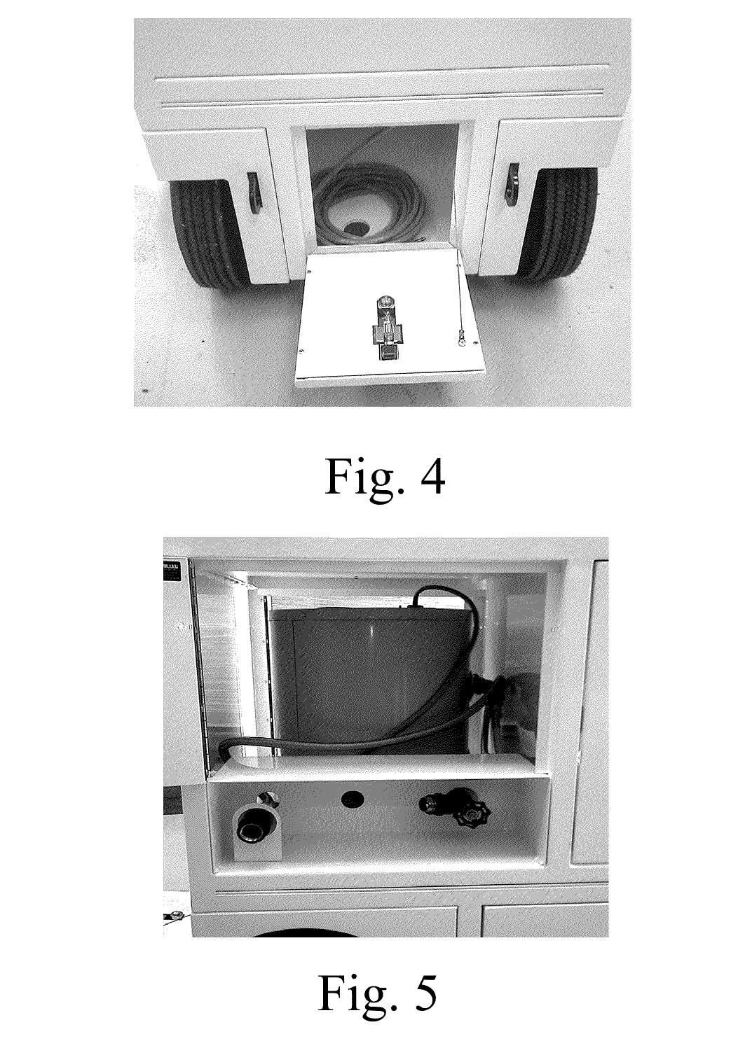

FIG. 4 is a side perspective view of the mobile medical wash station of the present invention showing a further storage area positioned on the side of the cabinet, as well as an integrated electrical cable for connection of the system to an external electrical power source (typically an AC outlet providing either 110 VAC or 220 VAC). Towing eyes are also provided on this side of the mobile unit.

FIG. 5 is a rear perspective view of the mobile medical wash station of the present invention showing the interior components and the external connections of the system. The back side of the hot water heater is seen in this view as are connections for a water supply and a liquid drain. Additional utility storage may be provided in these areas of the unit.

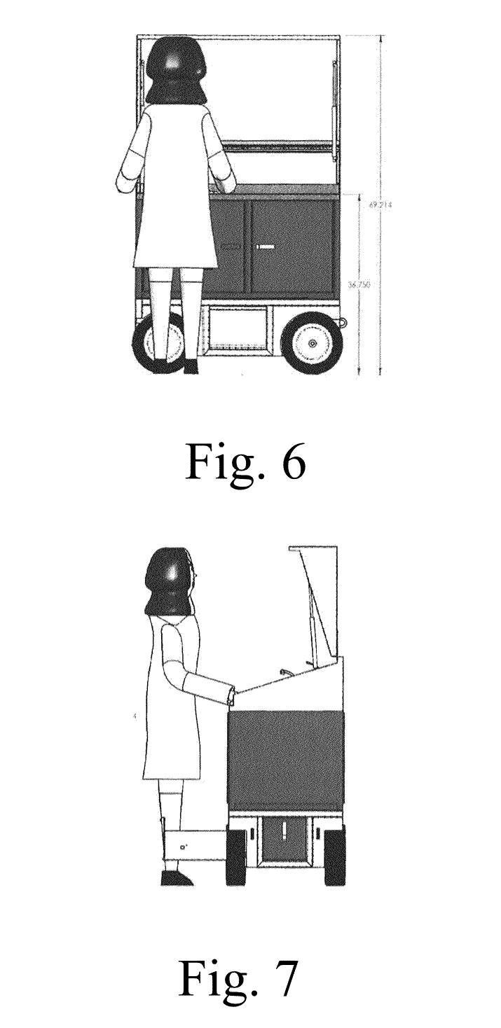

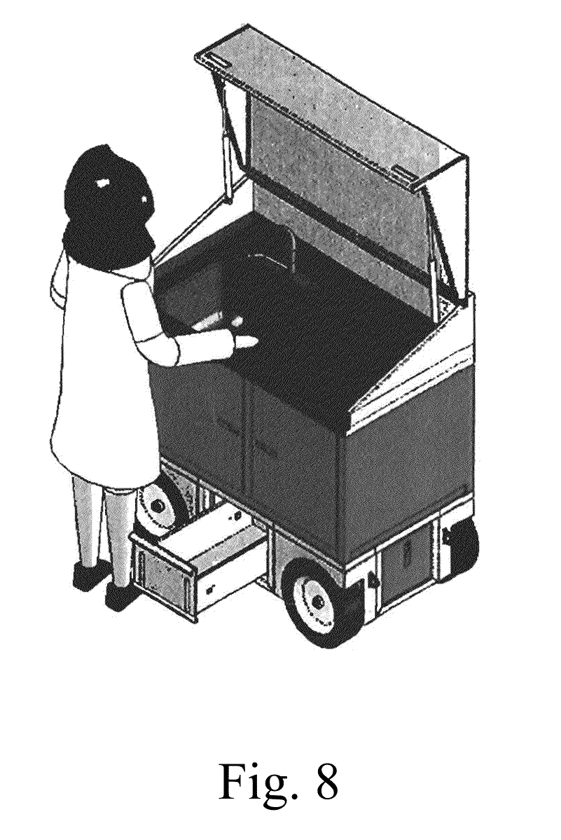

FIG. 6 is a front plan view of the mobile medical wash station of the present invention showing its preferred dimensions and the operating height of the unit with the cover component open. In this view the accessibility of the sink, counter, mirror, and cabinet components of the system can be seen. FIG. 7 is a side plan view of the mobile medical wash station of the present invention again showing its preferred dimensions and the manner in which a health care provider may utilize the facilities provided by the mobile unit. FIG. 8 is a further perspective view of the mobile medical wash station of the present invention showing the manner of its use.

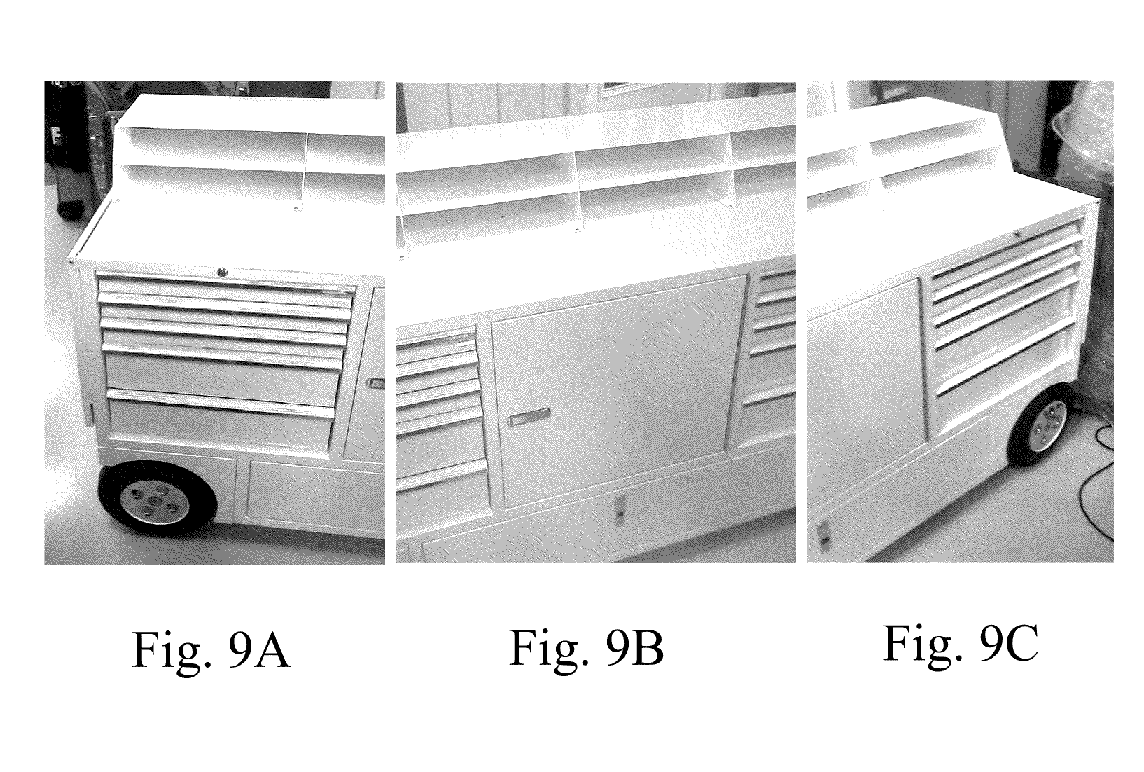

FIGS. 9A-9C are left side, center, and right side perspective views of the mobile medical nurses' station of the present invention. This unit, designed to be a companion unit to the mobile wash station, or to stand alone in its function, is configured on a mobile platform similar in many respects to the above described wash station. The features of this unit include a large table work surface such as might be found at a nurses' station in a hospital

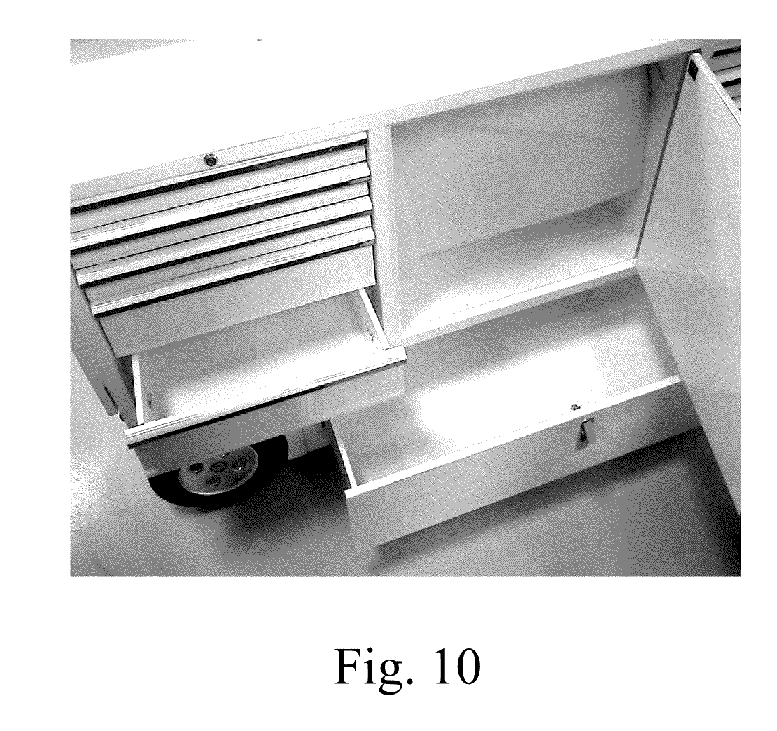

FIG. 10 is a perspective view of the mobile medical nurses' station of the present invention showing the open cabinets and drawers of the system. The intent of the mobile nurses' station component of the present invention is to provide a unit that is as much like a nurses' station in a hospital in its function and efficiency. Open drawers are available for patient charts, areas are positioned for laptop computers, storage drawers for medical and office supplies are provided. Hinged table top surfaces are positioned on each side of the unit (as seen in FIGS. 9A and 9C) which may be raised or lowered as necessary. The metal construction of the mobile units of the present invention provide durable, long lasting, low maintenance systems for carrying out required medical service functions in remote field locations.

Although the present invention has been described in terms of the foregoing preferred embodiments, this description has been provided by way of explanation only, and is not intended to be construed as limiting of the invention. Those skilled in the art will recognize modifications of the present invention that might accommodate specific medical service environments and health care provider needs. Such modifications, as to size, shape, construction material, and component arrangements, where such modifications are coincidental to the types of service being provided or the locations where such services are being provided, do not necessarily depart from the spirit and scope of the invention.

I claim:

1. A mobile medical wash station for use in conjunction with transitory medical and emergency facilities, capable of being rapidly transported to and from locations where such facilities are needed, the mobile wash station comprising:
a cabinet frame having a wheeled carriage, the wheeled carriage having at least two wheels positioned on rotatable casters;
a pull handle pivotally positioned on the cabinet frame in association with the at least two wheels positioned on rotatable casters;
a multi-compartment lower cabinet positioned within the cabinet frame on top of the wheeled carriage;
a hinged cover compartment positioned within the cabinet frame on top of the lower cabinet, the cover compartment comprising a hinged cover, an interior working surface, a water faucet, and a sink, the hinged cover compartment further comprising means for retaining the hinged cover in an open position so as to expose the working surface and the sink;
a water conduit system connecting the faucet to an external connection fitting for receiving a supply of water into the mobile station from an external water source;
an electrical supply system having an electrical connector for connecting to and receiving electrical power from an external electrical power source;
an electrically powered hot water heater having a hot water reservoir connected to the water conduit system and the faucet; and
a plurality of storage drawers positioned within the cabinet frame.

2. A mobile medical nurses' station for use in conjunction with transitory medical and emergency facilities, capable of being rapidly transported to and from locations where such facilities are needed, the mobile nurses' station comprising:
a cabinet frame having a wheeled carriage, the wheeled carriage having at least four wheels positioned on fixed axels;
a lower cabinet positioned within the cabinet frame in association with the wheeled carriage, the lower cabinet having a cabinet door with a latch;
a mid-center cabinet positioned within the cabinet frame above and centered over the lower cabinet, the mid-center cabinet having a cabinet door with a latch;
two sets of latchable drawers, a first set positioned to a first side of the mid-center cabinet over the lower cabinet and a second set positioned to an opposite side of the mid-center cabinet over the lower cabinet;
a working surface positioned over the two sets of drawers and the mid-center cabinet extending the full length of the mobile station, the working surface further comprising at least one hinged pivoting extension work surface, the extension work surface foldable between a dropped positioned adjacent one end of the mobile station and a locked raised position co-planar with the balance of the working surface; and
a plurality of open filing cabinet shelves positioned on top of the working surface to a rearward edge allowing access to both the working surface and the open shelves.
